(19) United States
(12) Patent Application Publication
(10) Pub. No.: US 2021/0362617 A1
(43) Pub. Date: Nov. 25, 2021

(54) CHARGING METHOD AND CHARGING SYSTEM

(71) Applicant: SEIKO EPSON CORPORATION, Tokyo (JP)

(72) Inventor: Yuki KOBARI, MATSUMOTO-SHI (JP)

(21) Appl. No.: 17/324,122

(22) Filed: May 19, 2021

(30) Foreign Application Priority Data
May 20, 2020 (JP) 2020-087938

(51) Int. Cl. B60L 53/62; B60L 58/12; B60L 53/66; B60L 53/36

(52) U.S. Cl. CPC B60L 53/62; B60L 53/36; B60L 53/66; B60L 58/12

(57) ABSTRACT

A charging method, in a charging system including a first robot having a first battery and a charging vehicle having a second battery, of charging the first battery includes determining whether or not remaining capacity of the first battery is equal to or lower than a first determination value by the robot, when the remaining capacity of the first battery is equal to or lower than the first determination value, transmitting a request signal for requesting charging of the first battery, and, when receiving the request signal, moving to a location of the robot and charging the first battery using the second battery by the charging vehicle.

The present application is based on, and claims priority from JP Application Serial Number 2020-087938, filed May 20, 2020, the disclosure of which is hereby incorporated by reference herein in its entirety.

### BACKGROUND

### 1. Technical Field

The present disclosure relates to a charging method and a charging system.

### 2. Related Art

JP-A-2006-231448 discloses a robot having a battery. According to the disclosure, the robot includes a manipulator and drive wheels. The robot can autonomously move and moves to a charging station when the remaining capacity of the battery is low.

However, it is difficult to work while the robot moves. The robot has a loss of work because movement to and from the charging station takes time. Accordingly, a charging method that enables charging of the battery without movement of the robot is desired.

### SUMMARY

A charging method is a charging method of charging a first battery in a charging system including a robot having the first battery and a charging vehicle having a second battery. The method includes causing the robot to determine whether or not remaining capacity of the first battery is equal to or lower than a first determination value, when the remaining capacity of the first battery is equal to or lower than the first determination value, transmitting a request signal for requesting charging of the first battery, and, when receiving the request signal, moving to a location of the robot and charging the first battery using the second battery by the charging vehicle.

A charging system includes a robot having a first battery and a transmitting section that transmits a request signal for requesting charging of the first battery when remaining capacity of the first battery is equal to or lower than a first determination value, and a charging vehicle having a second battery and a receiving section that receives the request signal, wherein the charging vehicle moves to a location of the robot and charges the first battery using the second battery.

### BRIEF DESCRIPTION OF THE DRAWINGS

FIG. 1 is a schematic diagram showing configurations of robots and charging vehicles according to a first embodiment.

FIG. 2 is a schematic diagram for explanation of coupling between the robot and the charging vehicle.

FIG. 3 is a schematic diagram for explanation of coupling between a charging station and the charging vehicle.

FIG. 4 is an electric control block diagram of the robot.

FIG. 5 is an electric control block diagram of the charging vehicle.

FIG. 6 is an electric control block diagram of a control apparatus.

FIG. 7 is a flowchart showing a charging method.

FIG. 8 is a flowchart showing a charging method according to a second embodiment.

FIG. 9 is a flowchart showing a charging method at a second charging vehicle charging step of step S12.

### DESCRIPTION OF EXEMPLARY EMBODIMENTS

### First Embodiment

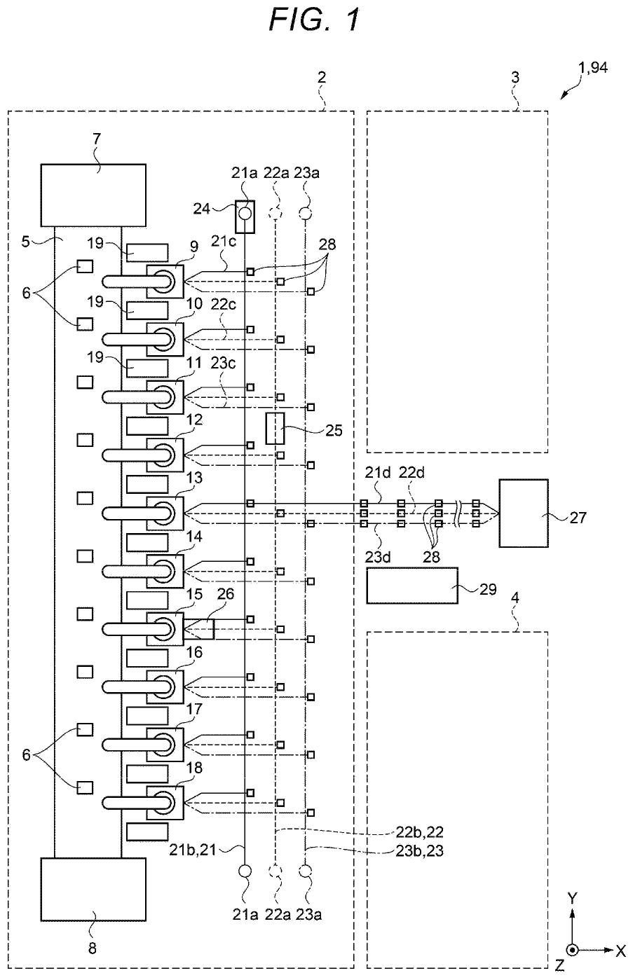

A charging method according to a first embodiment will be explained. As shown in FIG. 1, a factory 1 is divided into a first area 2, a second area 3, and a third area 4. The first area 2 will be explained. The second area 3 and the third area 4 are the same as the first area 2 and the explanation thereof will be omitted. The shape of the first area 2 is a rectangular shape. The longitudinal directions of the first area 2 are Y directions. The upward direction in the drawing is the Y positive direction. In the plane, directions orthogonal to the Y directions are X directions. The rightward direction in the drawing is the X positive direction. Directions orthogonal to the X directions and the Y directions are Z directions.

The first area 2 includes a belt conveyer 5 elongated in the Y directions. Workpieces 6 are mounted on the belt conveyer 5. The belt conveyer 5 moves the workpieces 6 from the Y positive direction to the Y negative direction. A supply apparatus 7 is placed at a side in the Y positive direction of the belt conveyer 5. The supply apparatus 7 supplies the workpieces 6 onto the belt conveyer 5. A collection apparatus 8 is placed at a side in the Y negative direction of the belt conveyer 5. The workpieces 6 reaching the collection apparatus 8 on the belt conveyer 5 are collected by the collection apparatus 8.

First robot 9 to tenth robot 18 as robots are placed along the belt conveyer 5 in the X positive direction of the belt conveyer 5. The first robot 9 to tenth robot 18 are placed in juxtaposition in the numerical order. Workbenches 19 are placed near the first robot 9 to tenth robot 18. On the workbenches 19, components etc. to be placed in the workpieces 6 are mounted. The first robot 9 to tenth robot 18 share work of placing and fastening the components by screws in the workpieces 6.

The first robot 9 to tenth robot 18 are not particularly limited, but may be six-axis robots or scalar robots. In the embodiment, for example, the first robot 9 to tenth robot 18 are six-axis robots. Note that the first robot 9 to tenth robot 18 may be robots movable by autonomously traveling. For example, the robots may be AMRs (Autonomous Mobile Robots).

On a floor at sides in the X positive direction of the first robot 9 to tenth robot 18, a first passage line 21, a second passage line 22, and a third passage line 23 are placed. The first passage line 21, the second passage line 22, and the third passage line 23 have a first main line 21b, a second main line 22b, and a third main line 23b extending in the Y directions, respectively. The first passage line 21, the second passage line 22, and the third passage line 23 have first branch lines 21c, second branch lines 22c, third branch lines 23c coupling from the first main line 21b, the second main line 22b, and the third main line 23b to the first robot 9 to tenth robot 18, respectively.

A first charging vehicle 24 as a charging vehicle is placed on the first passage line 21. The charging vehicle is a vehicle that charges batteries of the first robot 9 to tenth robot 18. The first charging vehicle 24 moves along the first passage line 21. The first main line 21b of the first passage line 21 has first waiting locations 21a on both ends. The first waiting locations 21a are locations where the first charging vehicle 24 waits. The first charging vehicle 24 in the drawing waits in the first waiting location 21a at the side in the Y positive direction. The charging vehicle may have another function in addition to charging of the batteries of the first robot 9 to tenth robot 18. For example, the vehicle may have a function of transporting objects.

A second charging vehicle 25 is placed on the second passage line 22. The second charging vehicle 25 moves along the second passage line 22. The second main line 22b of the second passage line 22 has second waiting locations 22a on both ends. The second waiting locations 22a are locations where the second charging vehicle 25 waits. The second charging vehicle 25 in the drawing moves on the main line of the second passage line 22.

A third charging vehicle 26 is placed on the third passage line 23. The third charging vehicle 26 moves along the third passage line 23. The third main line 23b of the third passage line 23 has third waiting locations 23a on both ends. The third waiting locations 23a are locations where the third charging vehicle 26 waits. The third charging vehicle 26 in the drawing couples to the seventh robot 15. The second charging vehicle 25 and the third charging vehicle 26 have the same function as the first charging vehicle 24.

The ten robots and the three charging vehicles are placed in the first area 2. The numbers and the placements of the robots and the charging vehicles are not limited. The first robot 9 to tenth robot 18 respectively have the batteries. The first charging vehicle 24 to third charging vehicle 26 charge the batteries of the first robot 9 to tenth robot 18.

A charging station 27 is placed at a side in the X positive direction of the fifth robot 13. The first charging vehicle 24 to third charging vehicle 26 respectively have batteries. The charging station 27 charges the batteries of the first charging vehicle 24 to third charging vehicle 26.

The first passage line 21 has a first sub-branch line 21d extending from the first main line 21b to the charging station 27. The second passage line 22 has a second sub-branch line 22d extending from the second main line 22b to the charging station 27. The third passage line 23 has a third sub-branch line 23d extending from the third main line 23b to the charging station 27.

Position marks 28 are placed near intersections between the first main line 21b and the first branch lines 21c, near intersections between the second main line 22b and the second branch lines 22c, and near intersections between the third main line 23b and the third branch lines 23c. The position marks 28 are placed at equal intervals on the first sub-branch line 21d, the second sub-branch line 22d, and the third sub-branch line 23d. The position marks 28 contain figures showing position information. When passing through the position marks 28, the first charging vehicle 24 to third charging vehicle 26 acquire the position information and detect current positions. For example, QR codes (registered trademark) are used for the position marks 28.

A control apparatus 29 is placed on a side in the X positive direction of the first area 2. The control apparatus 29 controls operation of the first charging vehicle 24 to third charging vehicle 26. The control apparatus 29 wirelessly communicates with the first robot 9 to tenth robot 18 and the first charging vehicle 24 to third charging vehicle 26. The control apparatus 29 monitors remaining capacity of the batteries of the first robot 9 to tenth robot 18 and the first charging vehicle 24 to third charging vehicle 26.

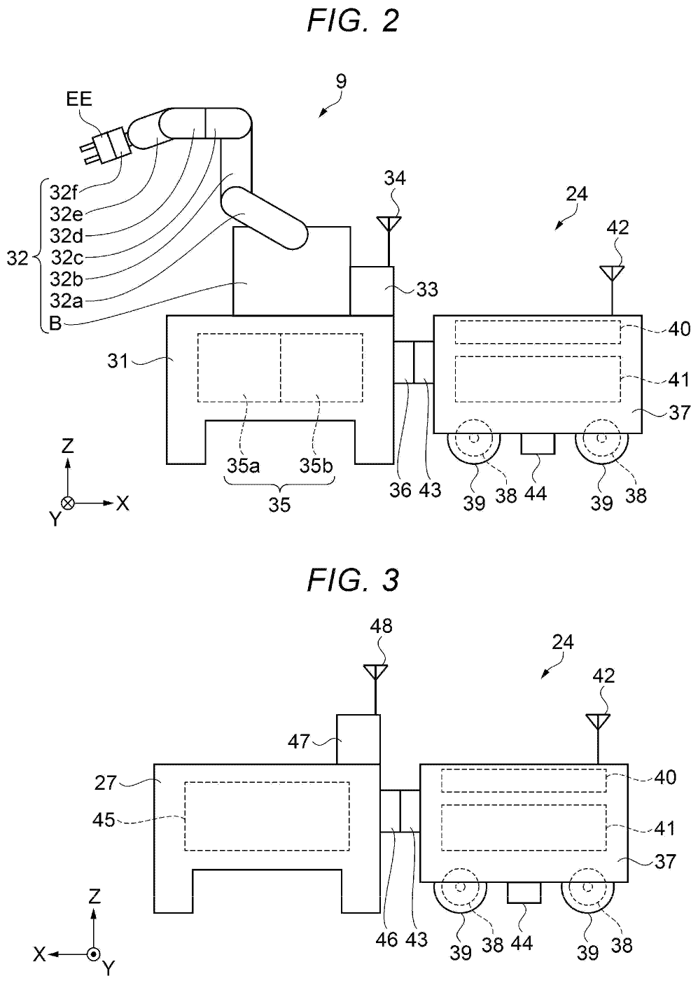

As shown in FIG. 2, the first robot 9 includes a platform 31. A robot main body 32 and a robot control unit 33 are placed on the platform 31. The robot control unit 33 includes a first antenna 34 and wirelessly communicates with the first charging vehicle 24 to third charging vehicle 26 and the control apparatus 29.

The robot main body 32 includes a base B, a first arm 32a, a second arm 32b, a third arm 32c, a fourth arm 32d, a fifth arm 32e, and a sixth arm 32f. An end effector EE is provided at the distal end side of the sixth arm 32f. The robot control unit 33 controls operation of the first arm 32a to sixth arm 32f.

The first robot 9 includes a first battery 35, and the first battery 35 is housed inside of the platform 31. The first battery 35 includes a main battery 35a and a sub-battery 35b. A first connector 36 is placed on a surface at a side in the X positive direction of the platform 31. The first connector 36 is electrically coupled to the first battery 35 via a battery switch unit. The robot main body 32 is driven by power of the first battery 35. The second robot 10 to tenth robot 18 as the robots have the same structure as the first robot 9.

The first charging vehicle 24 includes a vehicle body 37. Four motors 38 are placed in the vehicle body 37 and wheels 39 are fixed to the shafts of the respective motors 38. The vehicle body 37 is a four-wheel-drive electric car. The first charging vehicle 24 includes a charging vehicle control unit 40 and a second battery 41 inside of the vehicle body 37. The second battery 41 supplies power to the respective motors 38 and the charging vehicle control unit 40 controls rotation of the respective motors 38. The charging vehicle control unit 40 controls rotation directions and rotation speeds of the respective motors 38, and thereby, the first charging vehicle 24 moves forward, backward, clockwise, and counter-clockwise. Note that the vehicle body is not limited to the four-wheel-drive electric car, but may be a two-wheel-drive electric car. In this case, the two motors drive two of the wheels and the other wheels are following wheels that followingly move.

The charging vehicle control unit 40 includes a second antenna 42 and wirelessly communicates with the first robot 9 to tenth robot 18 and the control apparatus 29. A second connector 43 is placed on a surface at a side in the X negative direction of the vehicle body 37. The second connector 43 is electrically coupled to the second battery 41.

The first connector 36 and the second connector 43 can be coupled. When the first connector 36 and the second connector 43 are coupled to each other, power is transferred between the first battery 35 and the second battery 41. When the main battery 35a supplies power to the robot main body 32, the second battery 41 supplies power to the sub-battery 35b. Or, the sub-battery 35b supplies power to the second battery 41. When the sub-battery 35b supplies power to the robot main body 32, the second battery 41 supplies power to the main battery 35a. Or, the main battery 35a supplies power to the second battery 41. Therefore, power may be transferred between the first battery 35 and the second battery 41 while the robot main body 32 operates.

A track sensor 44 is placed on the bottom surface of the vehicle body 37. The track sensor 44 includes a two-dimensional digital camera. The track sensor 44 detects the first passage line 21 and the position marks 28. The second charging vehicle 25 and the third charging vehicle 26 have the same structure as the first charging vehicle 24 and the explanation will be omitted.

As shown in FIG. 3, the charging station 27 includes a power supply unit 45 inside. The power supply unit 45 converts and adjusts an alternating-current voltage into a direct-current voltage to a voltage to be charged in the second battery 41. The charging station 27 includes a third connector 46 at a side in the X negative direction. The third connector 46 and the second connector 43 can be coupled. When the third connector 46 and the second connector 43 are coupled, power is supplied from the power supply unit 45 to the second battery 41. The first connector 36, the second connector 43, and the third connector 46 include openable dustproof covers. When the first connector 36, the second connector 43, and the third connector 46 are not coupled, the dustproof covers are closed, and thereby, attachment of oil mist, dirt, and dust to electric terminals is suppressed.

The charging station 27 includes a station control unit 47 at a side in the Z positive direction. The station control unit 47 includes a third antenna 48 and wirelessly communicates with the first charging vehicle 24 to third charging vehicle 26 and the control apparatus 29. The station control unit 47 transmits information as to whether or not charging is being performed and an estimated time taken for charging during charging.

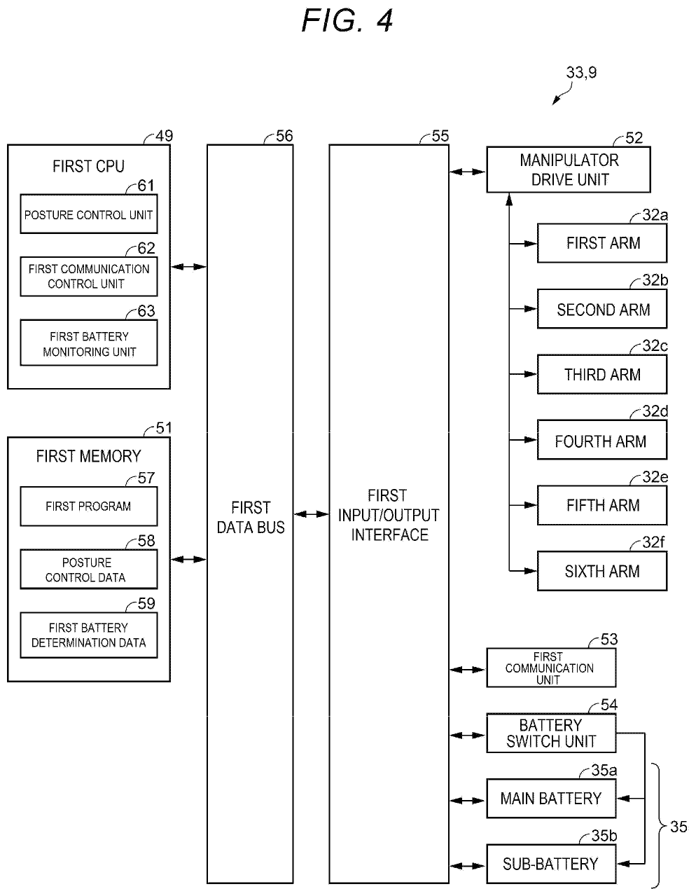

As shown in FIG. 4, the robot control unit 33 includes a first CPU 49 (Central Processing Unit) that performs various kinds of arithmetic processing as a processor, and a first memory 51 that stores various kinds of information. A manipulator drive unit 52, a first communication unit 53, a battery switch unit 54, the main battery 35a, and the sub-battery 35b are coupled to the first CPU 49 via a first input/output interface 55 and a first data bus 56.

The manipulator drive unit 52 is a circuit that drives the first arm 32a to sixth arm 32f. An instruction signal of the first CPU 49 is input to the manipulator drive unit 52. Then, the manipulator drive unit 52 drives the first arm 32a to sixth arm 32f according to the instruction signal. The end effector EE moves by actuation of the first arm 32a to sixth arm 32f.

The first communication unit 53 communicates with the first charging vehicle 24 to third charging vehicle 26 and the control apparatus 29. The first communication unit 53 transmits data of the amounts of charge of the batteries or a charging request signal according to a communication protocol.

The battery switch unit 54 switches the battery that supplies power to the robot main body 32 between the main battery 35a and the sub-battery 35b. An instruction signal of the first CPU 49 is input to the battery switch unit 54 and the battery switch unit 54 switches the battery according to the instruction signal. The main battery 35a and the sub-battery 35b include circuits that detect the remaining capacity and transmit values of the remaining power to the first CPU 49.

The first memory 51 includes a semiconductor memory such as a RAM or ROM or a storage device such as a hard disc. The first memory 51 stores a first program 57 in which control procedures of the operation of the robot main body 32 etc. are described. Further, the first memory 51 stores posture control data 58 as data for control of the postures of the first arm 32a to sixth arm 32f. Furthermore, the first memory 51 stores first battery determination data 59. The first battery determination data 59 contains a first determination value as determination data for determination as to whether or not charging of the first battery 35 is necessary. In addition, the first memory 51 includes memory areas that function as a work area, a temporary file, etc. for the first CPU 49 and other various memory areas.

The first CPU 49 controls the operation of the robot main body 32 according to the first program 57 stored within the first memory 51. The first CPU 49 has various functional units for realization of the functions. As a specific functional unit, the first CPU 49 has a posture control unit 61. The posture control unit 61 performs control of the movement speeds, the amounts of movement, the movement positions, etc. of the first arm 32a to sixth arm 32f. The posture control unit 61 outputs parameters for control of the robot main body 32 to the manipulator drive unit 52. Then, the manipulator drive unit 52 drives the first arm 32a to sixth arm 32f according to the parameters.

Further, the first CPU 49 has a first communication control unit 62. The first communication control unit 62 communicates with the first charging vehicle 24 to third charging vehicle 26 and the control apparatus 29 via the first communication unit 53. The first communication control unit 62 converts and outputs the remaining capacity of the first battery 35 and the charging request signal in formats of communication data to the first communication unit 53. The remaining capacity of the first battery 35 and the charging request signal are transmitted to the first charging vehicle 24 to third charging vehicle 26 and the control apparatus 29 via the first communication unit 53.

Furthermore, the first CPU 49 has a first battery monitoring unit 63. The first battery monitoring unit 63 monitors the remaining capacity of the first battery 35. When the remaining capacity of the first battery 35 is equal to or lower than the first determination value, the first battery monitoring unit 63, the first communication control unit 62, and the first communication unit 53 cooperatively transmit a request signal for charging the first battery 35 to the control apparatus 29. Note that the robot control units 33 of the second robot 10 to tenth robot 18 have the same structure as the robot control unit 33 of the first robot 9.

The first determination value may be set to a predetermined ratio relative to the power for fully charging the first battery 35. For example, in the embodiment, the first determination value is set to 20% of the power for fully charging the first battery 35.

Or, the first determination value may be set based on power consumption of the first robot 9, a working time, specifications of the first robot 9, a time taken for charging, or the like. Specifically, the details of work and the working time of the first robot 9 are almost set before the start of work, and the power consumption may be estimated. For example, the power consumption is calculated using weights of the workpieces 6, changes in angles of joints of the respective arms, changes in angular velocity of the joints, changes in acceleration of the joints, and an operating time. The first determination value is set so that the battery is charged before the remaining capacity of the battery of the first robot 9 is short based on the calculation result of the power consumption. When the details of work are changed, the first determination value is changed.

When the remaining capacity of the first battery 35 is equal to or lower than the first determination value, the posture control unit 61 may reduce the operation speed of the robot main body 32 to lower the decline rate of the remaining capacity of the first battery 35. The duration for work by the first robot 9 may be extended to be longer.

The first battery monitoring unit 63, the first communication control unit 62, and the first communication unit 53 form a transmitting section. The first battery monitoring unit 63 determines the remaining capacity of the first battery 35. When the first battery monitoring unit 63 determines that the remaining capacity of the first battery 35 is equal to or lower than the first determination value, the first communication control unit 62 and the first communication unit 53 transmit a request signal for requesting charging of the first battery 35.

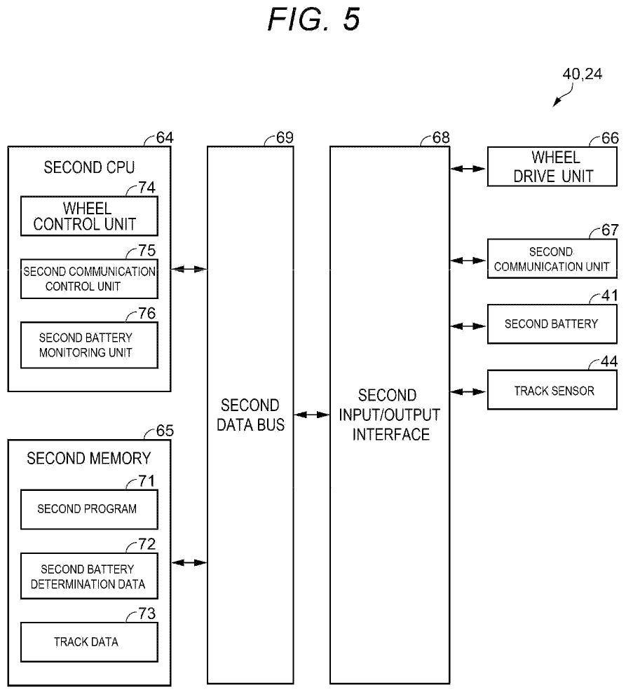

As shown in FIG. 5, the charging vehicle control unit 40 includes a second CPU 64 that performs various kinds of arithmetic processing as a processor, and a second memory 65 that stores various kinds of information. A wheel drive unit 66, a second communication unit 67, the second battery 41, and the track sensor 44 are coupled to the second CPU 64 via a second input/output interface 68 and a second data bus 69.

The wheel drive unit 66 is a circuit that drives the four motors 38. The wheel drive unit 66 inputs an instruction signal of the second CPU 64. Then, the wheel drive unit 66 drives the four motors 38 according to the instruction signal. The first charging vehicle 24 moves by the rotation of the four motors 38.

The second communication unit 67 communicates with the first robot 9 to tenth robot 18 and the control apparatus 29. The second communication unit 67 transmits data of the remaining capacity of the second battery 41 according to a communication protocol. The second battery 41 includes a circuit that detects the remaining capacity and transmits the value of the remaining capacity to the second CPU 64.

The track sensor 44 images the first passage line 21 and the position marks 28. The track sensor 44 transmits whether the first passage line 21 is linear or crossed to the second CPU 64. Further, when the position marks 28 are detected, the track sensor 44 transmits the details indicated by the position marks 28 to the second CPU 64.

The second memory 65 includes a semiconductor memory such as a RAM or ROM or a storage device such as a hard disc. The second memory 65 stores a second program 71 in which control procedures of the operation of the first charging vehicle 24 etc. are described. Further, the second memory 65 stores second battery determination data 72. The second battery determination data 72 contains a second determination value and a third determination value. The second determination value is determination data for determination as to whether or not charging of the second battery 41 is necessary after power is supplied to the first battery 35. The third determination value is determination data for determination as to whether or not charging of the second battery 41 is necessary before supply of power when a request to supply power to the first battery 35 is received. Furthermore, the second memory 65 stores track data 73. The track data 73 contains data representing a pattern of the first passage line 21. In addition, the second memory 65 includes memory areas that function as a work area, a temporary file, etc. for the second CPU 64 and other various memory areas.

Like the first determination value, the second determination value and the third determination value may be set to a predetermined ratio relative to the power for fully charging the second battery 41. For example, in the embodiment, the second determination value and the third determination value are set to 60% of the power for fully charging the second battery 41.

Or, the second determination value and the third determination value may be set based on the movement distance and the time taken for movement of the first charging vehicle 24, the capacity of the second battery 41, a frequency of reception of the request, or the like.

The second CPU 64 controls the operation of the first charging vehicle 24 according to the second program 71 stored within the second memory 65. The second CPU 64 has various functional units for realization of the functions. As a specific functional unit, the second CPU 64 has a wheel control unit 74. The wheel control unit 74 performs control of the rotation, non-rotation, rotation directions, rotation speeds, etc. of the four motors 38. The wheel control unit 74 outputs parameters for control of the respective motors 38 to the wheel drive unit 66. Then, the wheel drive unit 66 drives the respective motors 38 according to the parameters.

Further, the second CPU 64 has a second communication control unit 75. The second communication control unit 75 communicates with the first robot 9 to tenth robot 18 and the control apparatus 29 via the second communication unit 67. The second communication control unit 75 converts and outputs the remaining capacity of the second battery 41 and the data of the current position in formats of communication data to the second communication unit 67. The remaining capacity of the second battery 41 and the data of the current position are transmitted to the control apparatus 29 via the second communication unit 67.

The second communication control unit 75 and the second communication unit 67 form a receiving section. The second communication control unit 75 and the second communication unit 67 receive a request signal emitted by the first communication unit 53 of the first robot 9.

Further, the second CPU 64 has a second battery monitoring unit 76. The second battery monitoring unit 76 monitors the remaining capacity of the second battery 41. When the remaining capacity of the second battery 41 is equal to or lower than the second determination value, the second battery monitoring unit 76 transmits an instruction signal to the wheel control unit 74 to move the vehicle to the charging station 27.

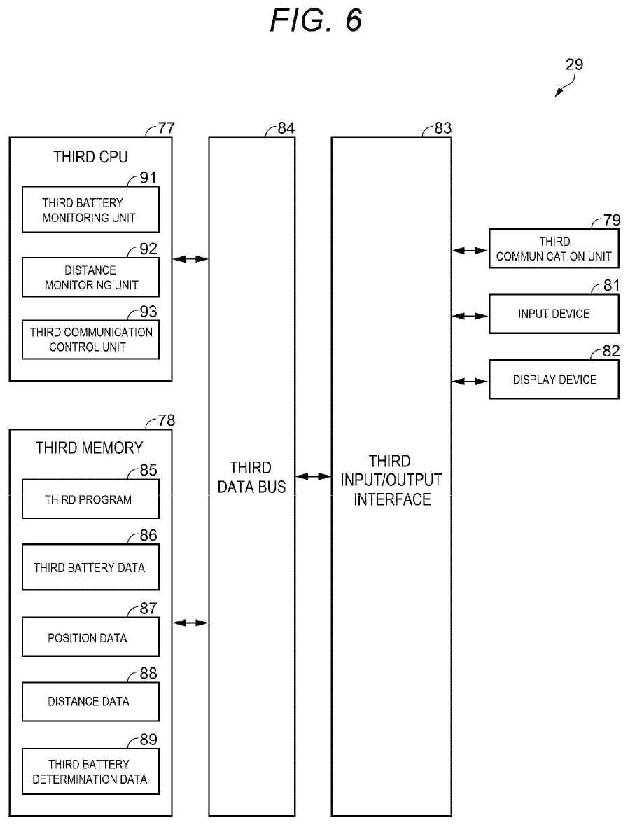

As shown in FIG. 6, the control apparatus 29 includes a third CPU 77 that performs various kinds of arithmetic processing as a processor, and a third memory 78 that stores various kinds of information. A third communication unit 79, an input device 81, and a display device 82 are coupled to the third CPU 77 via a third input/output interface 83 and a third data bus 84.

The third communication unit 79 communicates with the first robot 9 to tenth robot 18, the first charging vehicle 24 to third charging vehicle 26, and the charging station 27. The third communication unit 79 receives data of the remaining capacity of the first batteries 35 of the first robot 9 to tenth robot 18, the remaining capacity of the second batteries 41 of the first charging vehicle 24 to third charging vehicle 26, and the charging status of the charging station 27.

The input device 81 is a device to which an operator inputs data of the first determination value, the second determination value, the patterns of the first passage line 21 to third passage line 23, etc. The input device 81 includes e.g. a joystick, a keyboard, an electrostatic pad, a mouse pad, and a push-button switch. The operator operates the input device 81 to input various kinds of data.

For the display device 82, a liquid crystal display device, an organic EL (ELECTROLUMINESCENCE) display device, or the like is used. The display device 82 is a device that displays data and work statuses on the first robot 9 to tenth robot 18 and the first charging vehicle 24 to third charging vehicle 26. The operator performs input operation using the input device 81 with reference to information displayed on the display unit 82.

The third memory 78 includes a semiconductor memory such as a RAM or ROM or a storage device such as a hard disc. The third memory 78 stores a third program 85 in which control procedures to move the first charging vehicle 24 to third charging vehicle 26 etc. are described. Further, the third memory 78 stores third battery data 86. The third battery data 86 contains values of the remaining capacity of the first batteries 35 of the first robot 9 to tenth robot 18 and values of the remaining capacity of the second batteries 41 of the first charging vehicle 24 to third charging vehicle 26.

Furthermore, the third memory 78 stores position data 87. The position data 87 contains coordinate data representing the positions of the first robot 9 to tenth robot 18 and coordinate data representing the positions of the first charging vehicle 24 to third charging vehicle 26. In addition, the third memory 78 stores distance data 88. The distance data 88 contains data representing the respective distances between the first robot 9 to tenth robot 18 and the first charging vehicle 24 to third charging vehicle 26.

Further, the third memory 78 stores third battery determination data 89. The third battery determination data 89 contains the first determination value, the second determination value, the third determination value, and a fourth determination value. The fourth determination value is a determination value used for determination as to whether or not the remaining capacity of the first battery 35 of the robot is sufficient. Furthermore, the third memory 78 includes memory areas that function as a work area, a temporary file, etc. for the third CPU 77 and other various memory areas.

Like the first determination value, the fourth determination value may be set to a predetermined ratio relative to the power for fully charging the first battery 35. For example, in the embodiment, the fourth determination value is set to 80% of the power for fully charging the first battery 35.

Or, the fourth determination value may be set based on power consumption of the first robot 9, a working time, specifications of the first robot 9, a time taken for charging, or the like.

The third CPU 77 controls the charging operation of the first charging vehicle 24 to third charging vehicle 26 according to the third program 85 stored within the third memory 78. The third CPU 77 has various functional units for realization of the functions. As a specific functional unit, the third CPU 77 has a third battery monitoring unit 91. The third battery monitoring unit 91 receives the request signals transmitted by the first robot 9 to tenth robot 18. The third battery monitoring unit 91 transfers the request signal to the charging vehicle most suitable for charging of the first charging vehicle 24 to third charging vehicle 26.

Further, the third battery monitoring unit 91 collects and stores the values of the remaining capacity of the first batteries 35 of the first robot 9 to tenth robot 18 in the third memory 78. The third battery monitoring unit 91 collects and stores the values of the remaining capacity of the second batteries 41 of the first charging vehicle 24 to third charging vehicle 26 in the third memory 78. In this manner, the control apparatus 29 recognizes the remaining capacity of the first batteries 35 of the first robot 9 to tenth robot 18.

Further, the third CPU 77 has a distance monitoring unit 92. The distance monitoring unit 92 collects and stores distance information between the respective first robot 9 to tenth robot 18 and the respective first charging vehicle 24 to third charging vehicle 26 in the third memory 78. The distance information on the first charging vehicle 24 is distance information when the first charging vehicle 24 moves along the first passage line 21. For example, when the request signal for charging is received from the first robot 9, information as to which of the first charging vehicle 24 to third charging vehicle 26 is the charging vehicle nearest the first robot 9 is transmitted to the third battery monitoring unit 91.

Furthermore, the third CPU 77 has a third communication control unit 93. The third communication control unit 93 communicates with the first robot 9 to tenth robot 18 and the first charging vehicle 24 to third charging vehicle 26 via the third communication unit 79. The third communication control unit 93 outputs a signal for requesting data of the remaining capacity of the second battery 41 or the current position to the first charging vehicle 24 to third charging vehicle 26 via the third communication unit 79. The third communication control unit 93 receives and stores data transmitted by the first robot 9 to tenth robot 18 and the first charging vehicle 24 to third charging vehicle 26 via the third communication unit 79 in the third memory 78.

The first robot 9 to tenth robot 18, the first charging vehicle 24 to third charging vehicle 26, the charging station 27, the control apparatus 29, etc. form a charging system 94.

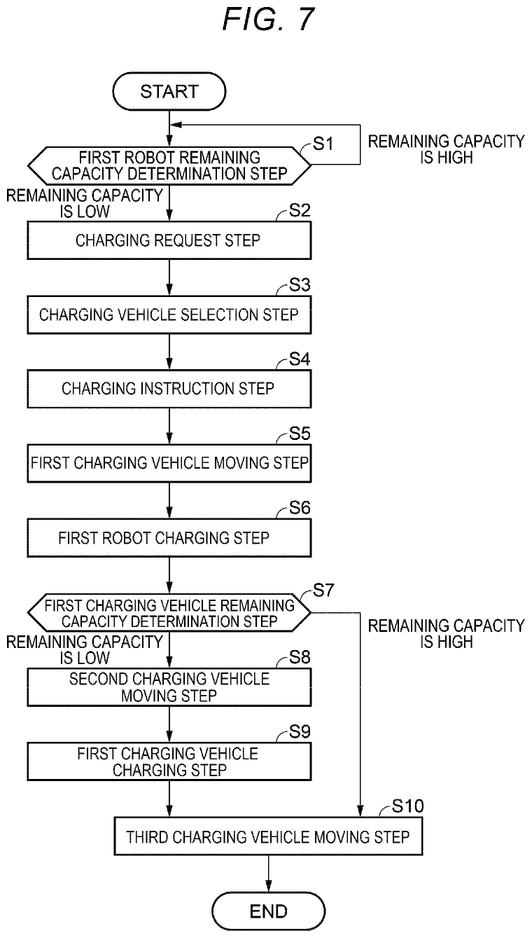

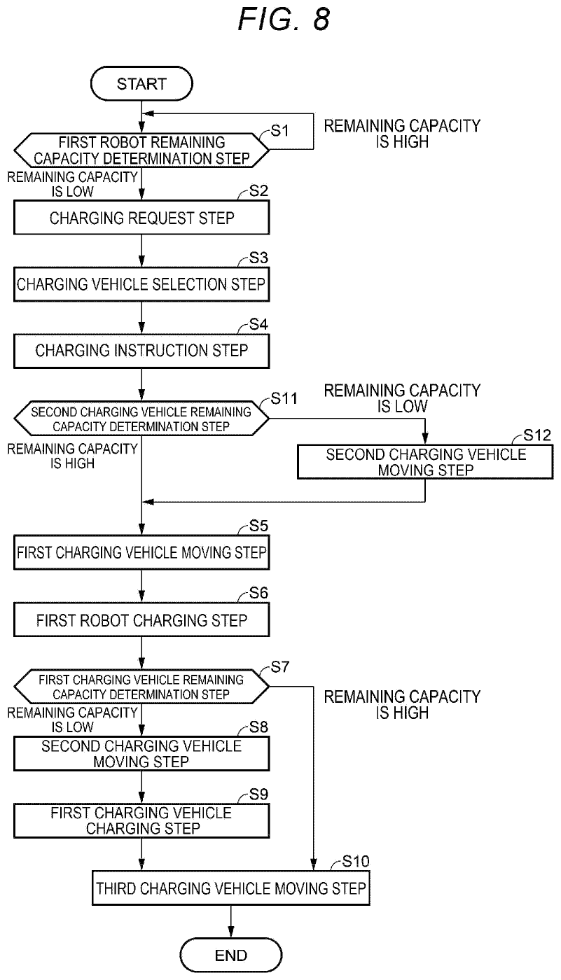

Next, procedures of a charging method of charging the first battery 35 of the first robot 9 by the first charging vehicle 24 will be explained using FIG. 7. Note that procedures to charge the first batteries 35 of the first robot 9 to tenth robot 18 by the first charging vehicle 24 to third charging vehicle 26 are substantially the same.

Step S1 is a first robot remaining capacity determination step. This step is a step at which the first battery monitoring unit 63 of the first robot 9 determines the remaining capacity of the first battery 35. The first battery monitoring unit 63 of the first robot 9 determines whether or not the remaining capacity of the first battery 35 is equal to or lower than the first determination value. When the remaining capacity of the first battery 35 is equal to or lower than the first determination value, the process moves to step S2. When the remaining capacity of the first battery 35 is higher than the first determination value, the process continues step S1.

Step S2 is a charging request step. At this step, the first communication control unit 62 and the first communication unit 53 of the first robot 9 transmit the request signal for requesting charging of the first battery 35 to the control apparatus 29. The third communication control unit 93 of the control apparatus 29 receives the request signal from the first robot 9. Then, the process moves to step S3.

Step S3 is a charging vehicle selection step. At this step, the distance monitoring unit 92 of the control apparatus 29 recognizes the position of the first robot 9 and the positions of the first charging vehicle 24 to third charging vehicle 26. The distance monitoring unit 92 searches for the charging vehicle near the first robot 9 transmitting the request signal. In the example of FIG. 1, the distance monitoring unit 92 transmits information that, of the first charging vehicle 24 to third charging vehicle 26, the first charging vehicle 24 is nearest the first robot 9 and the second charging vehicle 25 is second nearest the first robot 9 to the third battery monitoring unit 91.

Step S4 is a charging instruction step. At this step, the third communication control unit 93 transmits the request signal to the first charging vehicle 24 near the first robot 9 transmitting the request signal. The first charging vehicle 24 including the second battery 41 receives the request signal. Then, the process moves to step S5.

Step S5 is a first charging vehicle moving step. This step is a step at which the first charging vehicle 24 moves to the first robot 9 to be charged. Then, the process moves to step S6.

According to the method, the charging vehicle 24 near the first robot 9 having the first battery 35 with the low remaining capacity moves for charging. The first charging vehicle 24 reaches the first robot 9 to be charged in a shorter time when the movement distance is longer than that when the movement distance is shorter. Therefore, in the first robot 9, the time taken for charging the first battery 35 may be shortened.

Step S6 is a first robot charging step. This step is a step of charging the first battery 35 of the first robot 9 by the second battery 41 of the first charging vehicle 24. The first battery 35 includes the main battery 35a and the sub-battery 35b. The battery switch unit 54 sets one battery for activation of the robot main body 32 and the other for charging. For example, while the main battery 35a supplies power to the robot main body 32, the first charging vehicle 24 charges the sub-battery 35b. Then, the battery switch unit 54 sets the sub-battery 35b for activation of the robot main body 32. While the sub-battery 35b supplies power to the robot main body 32, the first charging vehicle 24 charges the main battery 35a. In this manner, power supply to the robot main body 32 and charging of the first battery 35 are performed in parallel. Then, the process moves to step S7.

According to the charging method in the charging system, when the remaining capacity of the first battery 35 of the first robot 9 is low, the first robot 9 transmits the request signal for charging the first battery 35 to the first charging vehicle 24 via the control apparatus 29. The first charging vehicle 24 receives the request signal and charges the first battery 35. Therefore, the first robot 9 may charge the first battery 35 without moving.

Step S7 is a first charging vehicle remaining capacity determination step. This step is a step at which the second battery monitoring unit 76 of the first charging vehicle 24 determines whether or not the remaining capacity of the second battery 41 is equal to or lower than the second determination value after the first charging vehicle 24 charges the first battery 35. When the remaining capacity of the second battery 41 is equal to or lower than the second determination value and the remaining capacity of the second battery 41 is low, the process moves to step S8. When the remaining capacity of the second battery 41 is higher than the second determination value and the remaining capacity of the second battery 41 is high, the process moves to step S10.

Step S8 is a second charging vehicle moving step. This step is a step at which the first charging vehicle 24 moves to the charging station 27. Then, the process moves to step S9.

Step S9 is a first charging vehicle charging step. This step is a step at which the first charging vehicle 24 charges the second battery 41 in the charging station 27. The charging station 27 supplies power to the second battery 41 of the first charging vehicle 24. Then, the process moves to step S10.

According to the method, when the remaining capacity of the second battery 41 is low, the first charging vehicle 24 moves to the charging station 27 and charges the second battery 41. Therefore, the charging vehicle may wait with the high remaining capacity of the second battery 41.

Step S10 is a third charging vehicle moving step. This step is a step at which the first charging vehicle 24 moves to the first waiting location 21a. Through the above described steps, the procedures to charge the first battery 35 of the first robot 9 by the first charging vehicle 24 end.

Note that it is preferable that the first charging vehicle 24 to third charging vehicle 26 move to the charging station 27 and charge the second batteries 41 as necessary when not charging the first batteries 35 of the robots and the second batteries 41 are not fully charged. When receiving the request signals, the first charging vehicle 24 to third charging vehicle 26 may start movement to the robots for charging the first batteries 35.

### Second Embodiment

The embodiment is different from the first embodiment in that the first charging vehicle 24 charges the second battery 41 in the charging station 27, and then, charges the first battery 35 of the first robot 9. Note that the same steps as those of the first embodiment have the same signs and the overlapping description will be omitted.

In FIG. 8, step S1 to step S4 are performed in the same manner as that of the first embodiment. After step S4, the process moves to step S11.

Step S11 is a second charging vehicle remaining capacity determination step. This step is a step at which the first charging vehicle 24 determines whether or not the remaining capacity of the second battery 41 is equal to or lower than the third determination value when the first charging vehicle 24 receives the request signal for charging the first battery 35. When the remaining capacity of the second battery 41 is equal to or lower than the third determination value and the remaining capacity of the second battery 41 is low, the process moves to step S12. When the remaining capacity of the second battery 41 is higher than the third determination value and the remaining capacity of the second battery 41 is high, the process moves to step S5.

Step S12 is a second charging vehicle charging step. This step is a step at which the first charging vehicle 24 moves to the charging station 27 and charges the second battery 41 when the remaining capacity of the second battery 41 is equal to or lower than the third determination value. Or, this step is a step at which the first charging vehicle 24 moves to the robot with the sufficient remaining capacity and charges the second battery 41. Then, the process moves to step S5.

Subsequent to step S11 and step S12, step S5 to step S10 are performed like those of the first embodiment. According to the method, when the remaining capacity of the second battery 41 is low, the first charging vehicle 24 moves to the charging station 27 and charges the second battery 41. Therefore, even when the remaining capacity is low, the first charging vehicle 24 may charge the first battery 35 of the first robot 9.

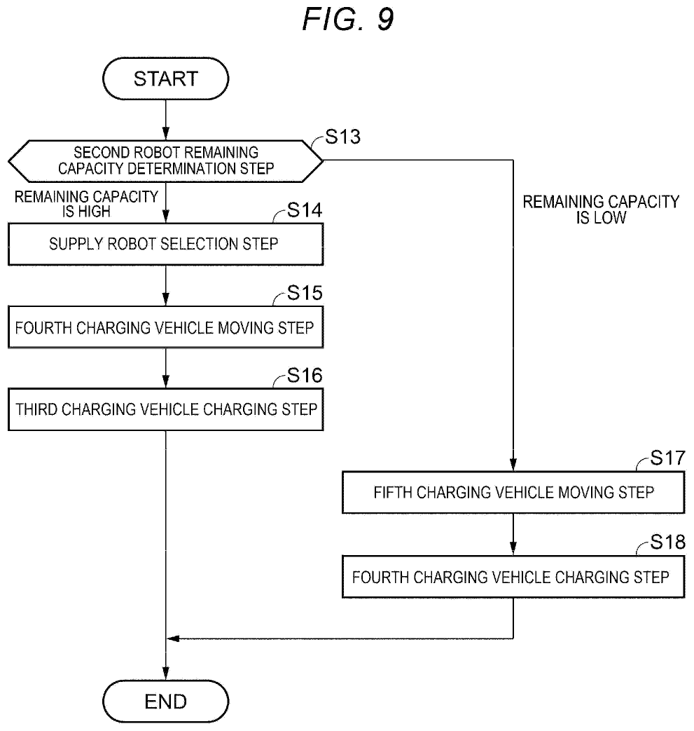

As shown in FIG. 9, at the second charging vehicle charging step of step S12, step S13 to step S18 are performed. After step S18, the process moves to step S5.

Step S13 is a second robot remaining capacity determination step. At this step, when the remaining capacity of the second battery 41 of the first charging vehicle 24 is equal to or lower than the third determination value, the first charging vehicle 24 transmits an inquiry signal for an inquiry of the robot having the high remaining capacity of the first battery 35 to the control apparatus 29.

In the control apparatus 29, the third battery monitoring unit 91 searches for the robot having the remaining capacity of the first battery 35 equal to or higher than the fourth determination value using the third battery data 86. The control apparatus 29 determines whether or not there is the robot having the remaining capacity of the first battery 35 equal to or higher than the fourth determination value.

When there is no robot having the remaining capacity of the first battery 35 equal to or higher than the fourth determination value and the remaining capacity of the first batteries 35 is low in all of the robots, the control apparatus 29 transmits a response signal indicating that there is no robot having the remaining capacity of the first battery 35 equal to or higher than the fourth determination value to the first charging vehicle 24. Then, the process moves to step S17.

When there is the robot having the remaining capacity of the first battery 35 equal to or higher than the fourth determination value, that is, when there is the robot having the high remaining capacity, the process moves to step S14.

Step S14 is a supply robot selection step. At this step, the third battery monitoring unit 91 selects the robot in which the time until the remaining capacity of the first battery 35 reaches the fourth determination value is estimated to be the longest. The control apparatus 29 transmits a response signal indicating that the robot having the remaining capacity of the first battery 35 equal to or higher than the fourth determination value to the first charging vehicle 24. The robot indicated by the response signal is the robot in which the time until the remaining capacity of the first battery 35 reaches the fourth determination value is estimated to be the longest. Then, the first charging vehicle 24 receives the response signal. Then, the process moves to step S15.

Step S15 is a fourth charging vehicle moving step. At this step, the first charging vehicle 24 moves to the robot indicated by the response signal. For example, it is assumed that the robot indicated by the response signal is the second robot 10. Then, the process moves to step S16.

Step S16 is a third charging vehicle charging step. At this step, the second battery 41 of the first charging vehicle 24 is electrically coupled to the first battery 35 of the second robot 10, and then, the first battery 35 of the second robot 10 charges the second battery 41 of the first charging vehicle 24. Then, the process moves to step S5.

According to the method, when the remaining capacity of the second batteries 41 is low, the first charging vehicle 24 charges power from the second robot 10 including the first battery 35 having the high remaining capacity. Then, the first charging vehicle 24 charges the first battery 35 of the requested first robot 9. Therefore, the first battery 35 of the requested first robot 9 may be charged in a shorter time even when the movement to the charging station 27 takes time.

Step S17 is a fifth charging vehicle moving step. This step is a step at which the first charging vehicle 24 moves to the charging station 27. Then, the process moves to step S18.

Step S18 is a fourth charging vehicle charging step. This step is a step at which the first charging vehicle 24 charges the second battery 41 in the charging station 27. The charging station 27 supplies power to the second battery 41 of the first charging vehicle 24. Then, the process moves to step S5. Through the above described steps, the procedures to charge the first battery 35 of the first robot 9 by the first charging vehicle 24 end.

### Third Embodiment

The embodiment is different from the first embodiment in that the third communication control unit 93 transmits the request signal to the charging vehicle having the highest remaining capacity at step S4.

Step S1 and step S2 are performed in the same manner as that of the first embodiment. At the charging vehicle selection step of step S3, the third battery monitoring unit 91 of the control apparatus 29 recognizes the remaining capacity of the second batteries 41 of the first charging vehicle 24 to third charging vehicle 26. The distance monitoring unit 92 searches for the charging vehicle having the highest remaining capacity of the second battery 41. For example, it is assumed that, of the first charging vehicle 24 to third charging vehicle 26, the remaining capacity of the second battery 41 of the first charging vehicle 24 is the highest. The third battery monitoring unit 91 determines that the first charging vehicle 24 is the charging vehicle having the highest remaining capacity of the second battery 41. Then, the process moves to step S4.

At the charging instruction step of step S4, the control apparatus 29 transmits the request signal to the first charging vehicle 24 having the highest remaining capacity of the second battery 41. Then, the first charging vehicle 24 receives the request signal. Then, the process moves to step S5.

At the first charging vehicle moving step of step S5, the first charging vehicle 24 moves to the first robot 9 to be charged. Subsequently, step S6 to step S10 are performed.

According to the method, the first charging vehicle 24 having the highest remaining capacity of the second battery 41 moves for charging. The first charging vehicle 24 having the highest remaining capacity of the second battery 41 may supply higher power to the first battery 35 than the charging vehicle having the low remaining capacity of the second battery 41.

### Fourth Embodiment

In the first embodiment, the first connector 36 of the first robot 9 and the second connector 43 of the first charging vehicle 24 come into contact and charging is performed between the first battery 35 and the second battery 41. Or, the first robot 9 may include a first coil electrically coupled to the first battery 35 and the first charging vehicle 24 may include a second coil electrically coupled to the second battery 41. Then, power may be contactlessly transmitted between the first coil and the second coil. The first robot 9 and the first charging vehicle 24 may wirelessly transmit power. Power loss due to dirty terminals of the first connector 36 and the second connector 43 may be reduced.

Similarly, the charging station 27 may include a third coil. Then, power may be contactlessly transmitted between the second coil and the third coil. The charging station 27 and the first charging vehicle 24 may wirelessly transmit power. Power loss due to dirty terminals of the third connector 46 and the second connector 43 may be reduced.

### Fifth Embodiment

In the first embodiment, the request signal transmitted by the first robot 9 is received by the control apparatus 29. Then, the control apparatus 29 selects the charging vehicle and transfers the request signal. However, the request signal transmitted by the first robot 9 may be received by the charging vehicle. The chargeable charging vehicle among the first charging vehicle 24 to third charging vehicle 26 may charge the first battery 35 of the first robot 9. The control apparatus 29 is not used, and thereby, the charging system 94 may be easily constructed.

### Sixth Embodiment

In the first embodiment, the charging vehicle near the robot transmitting the request signal performs charging. In the third embodiment, the charging vehicle having the high remaining capacity performs charging. Or, when the remaining capacity of the first charging vehicle 24 to third charging vehicle 26 is low, the charging vehicle near the charging station 27 may perform charging.

Or, when the remaining capacity of the first charging vehicle 24 to third charging vehicle 26 is low and there is the robot having the high remaining capacity, the charging vehicle near the robot having the high remaining capacity may perform charging. That is, power is supplied from the robot having the high remaining capacity to the charging vehicle near the robot having the high remaining capacity. Or, power may be supplied to the robot transmitting the request signal by the charging vehicle.

Or, when power is supplied from the robot having the high remaining capacity to the charging vehicle, the control apparatus 29 may select the robot that supplies power to the charging vehicle in consideration of the amount of power charged by the charging vehicle and the amount of power consumed in work scheduled for the robot.

Or, when a plurality of robots transmit the request signals to the control apparatus 29, the control apparatus 29 may make a schedule for charging the plurality of robots by a plurality of charging vehicles.

### Seventh Embodiment

In the first embodiment, the first battery monitoring units 63 of the first robot 9 to tenth robot 18 monitor the remaining capacity of the first batteries 35. Or, the data of the remaining capacity of the first batteries 35 of the first robot 9 to tenth robot 18 may be transmitted to the control apparatus 29 on a regular basis. Then, the control apparatus 29 may monitor the remaining capacity of the first batteries 35 of the first robot 9 to tenth robot 18. When the remaining capacity of the first batteries 35 of the first robot 9 to tenth robot 18 becomes lower, the control apparatus 29 may transmit the request signals to the first charging vehicle 24 to third charging vehicle 26.

### Eighth Embodiment

In the first embodiment, the first robot 9 to tenth robot 18 are robots not autonomously moving. The first robot 9 to tenth robot 18 may autonomously move. The first charging vehicle 24 to third charging vehicle 26 may charge the batteries of the robots in shorter times than those when the robots move to the charging station 27.

### Ninth Embodiment

In the first embodiment, the first passage line 21, the second passage line 22, and the third passage line 23 are placed on the floor. Or, the first charging vehicle 24 to third charging vehicle 26 may have map information. Then, the first charging vehicle 24 to third charging vehicle 26 may move using the map information and the position marks 28. In this regard, it is preferable that some of the position marks 28 are located near the first robot 9 to tenth robot 18.

Or, the control apparatus 29 may have map information. Then, the first charging vehicle 24 to third charging vehicle 26 detect the position marks 28 and transmit information of the position marks 28 to the control apparatus 29. The control apparatus 29 receives the information of the position marks 28 detected from the first charging vehicle 24 to third charging vehicle 26. The control apparatus 29 may guide the first charging vehicle 24 to third charging vehicle 26 using the map information and the information of the position marks 28.

Or, the first charging vehicle 24 to third charging vehicle 26 may include GPS (Global Positioning System). The first charging vehicle 24 to third charging vehicle 26 transmit position information to the control apparatus 29. The control apparatus 29 receives the position information from the first charging vehicle 24 to third charging vehicle 26. The control apparatus 29 may have the map information and guide the first charging vehicle 24 to third charging vehicle 26 using the map information and the position information.

### Tenth Embodiment

In the first embodiment, the first robot 9 to tenth robot 18, the first charging vehicle 24 to third charging vehicle 26, the charging station 27, and the control apparatus 29 wirelessly communicate with one another. In a case where electromagnetic noise within the factory 1 is higher, optical communications may be employed. Thereby, data communications in good condition may be performed.

What is claimed is:

1. A charging method of charging a first battery in a charging system including a robot having the first battery and a plurality of charging vehicles having second batteries, the method comprising:
causing the robot to determine whether or not remaining capacity of the first battery is equal to or lower than a first determination value;
when the remaining capacity of the first battery is equal to or lower than the first determination value, transmitting a request signal for requesting charging of the first battery; and
when receiving the request signal, moving to a location of the robot and charging the first battery using the second battery by the charging vehicle.

2. The charging method according to claim 1, further comprising:
causing a control apparatus to recognize a position of the robot and positions of the plurality of charging vehicles; and
causing the control apparatus to receive the request signal from the robot and transmitting the request signal to the charging vehicle nearest the robot transmitting the request signal among the plurality of charging vehicles.

3. The charging method according to claim 1, further comprising:
causing a control apparatus to recognize remaining capacity of the second batteries of the plurality of charging vehicles; and
causing the control apparatus to receive the request signal from the robot and transmitting the request signal to the charging vehicle including the second battery having the highest remaining capacity among the plurality of charging vehicles.

4. The charging method according to claim 1, further comprising:
after charging the first battery by the charging vehicle, causing the charging vehicle to determine whether or not remaining capacity of the second battery is equal to or lower than a second determination value; and
when the remaining capacity of the second battery is equal to or lower than the second determination value, causing the charging vehicle to move to a charging station and charge the second battery.

5. The charging method according to claim 1, further comprising:
when receiving the request signal by the charging vehicle, causing the charging vehicle to determine whether or not remaining capacity of the second battery is equal to or lower than a third determination value; and
when the remaining capacity of the second battery is equal to or lower than the third determination value, causing the charging vehicle to move to a charging station and charge the second battery.

6. The charging method according to claim 2, further comprising:
causing the control apparatus to recognize the remaining capacity of the first battery of the robot;
when receiving the request signal by the charging vehicle, causing the charging vehicle to determine whether or not remaining capacity of the second battery is equal to or lower than a third determination value;
when the remaining capacity of the second battery is equal to or lower than the third determination value, causing the charging vehicle to transmit an inquiry signal for an inquiry of information on the remaining capacity of the first battery to the control apparatus;
causing the control apparatus to transmit a response signal indicating the robot having the remaining capacity of the first battery equal to or higher than a fourth determination value to the charging vehicle; and
causing the charging vehicle to receive the response signal and moving to the robot indicated by the response signal and charging the second battery.

7. A charging system comprising:
a robot having a first battery and a transmitting section that transmits a request signal for requesting charging of the first battery when remaining capacity of the first battery is equal to or lower than a first determination value; and
a charging vehicle having a second battery and a receiving section that receives the request signal, wherein
the charging vehicle moves to a location of the robot and charges the first battery using the second battery.
